(19) United States
(12) Patent Application Publication
(10) Pub. No.: US 2004/0026002 A1
(43) Pub. Date: Feb. 12, 2004

(54) Lightweight gypsum board product and method of manufacture

(76) Inventors: Walter Weldon, Gainesville, VA (US); Steven Roy Butler, Le Thor (FR); David Downs, Forest, VA (US)

Correspondence Address: BURNS, DOANE, SWECKER & MATHIS, L.L.P., P.O. Box 1404, Alexandria, VA, 22313-1404, US

(21) Appl. No.: 10/358,145

(22) Filed: Feb. 5, 2003

Related U.S. Application Data
(63) Continuation of application No. PCT/US01/41578, filed on Aug. 7, 2001.
(60) Provisional application No. 60/223,320, filed on Aug. 7, 2000.

(51) Int. Cl. B28B 3/00; B32B 13/00; B32B 13/08; B32B 31/06

(52) U.S. Cl. 156/43; 156/39; 156/45; 264/333

(57) ABSTRACT

A method of making a gypsum board includes mixing together gypsum and water in a mixer to form a gypsum slurry; discharging the gypsum slurry onto a first facing sheet; laying a second facing sheet on top of the discharged gypsum slurry; passing the gypsum slurry and facing sheets through a forming station to form the slurry to a desired thickness; allowing the formed gypsum slurry to set; removing at least one of the facing sheets from the set gypsum; cutting the set gypsum into boards; and drying the cut gypsum boards.

### CROSS-REFERENCE TO RELATED APPLICATIONS

The present application is a continuation of PCT/US01/41578, filed on Aug. 7, 2001, which claims the benefit of US provisional application number 60/223,320, filed on Aug. 7, 2000, the entire contents of which are hereby incorporated herein by reference.

### BACKGROUND

1. Field of the Invention

The present invention is directed to gypsum board products. More specifically, the present invention is directed to a lightweight gypsum board product, and the production thereof, for use in walls, ceilings, or other suitable applications.

2. Background Information

In the description of the background of the present invention that follows reference is made to certain structures and methods, however, such references should not necessarily be construed as an admission that these structures and methods qualify as prior art under the applicable statutory provisions. Applicants reserve the right to demonstrate that any of the referenced subject matter does not constitute prior art with regard to the present invention.

The product density and surface type and finish of traditional gypsum board products are manufactured to display desired strength and appearance while minimizing product weight and costs. Generally, calcined gypsum slurry is agitated in a mixer with foam or aqueous foaming agents and deposited onto a conveyor carrying a facing sheet. A backing sheet is applied over the slurry and the wet gypsum board product is formed to the desired thickness between forming rollers. The wet gypsum sets during the conveying process, is cut to the desired length, and is dried by passing the gypsum board product through a drying oven.

Prior to the present invention, conventional gypsum wallboard typically had a weight of about 1,700 or 1,800 lbs. per thousand square feet. Such boards provided adequate strength and nail pull resistance. However, such boards are heavy and inconvenient to transport and manipulate when used for building. Whereas the industry has been interested in the production of a suitable lightweight or low density gypsum wallboard, it was generally regarded that such lightweight wallboards may not have adequate strength or nail pull resistance.

There are several process variables to be controlled including the composition of the gypsum slurry, the agitation of the slurry, and the use and insertion of any foam or foaming agent.

One process variable is the composition of the stucco. For example, calcined gypsum can be in one of two forms. α-gypsum is a needle-like variant that has a long set time and contributes to a strong gypsum board product. In contrast, traditional β-gypsum is platen-like, has a faster setting time, and results in a gypsum board product that is not as strong as a board made from α-gypsum. Although, β-gypsum can be used in a lightweight gypsum board product, its use can compound the previously recognized difficulties of strength and nail pull and result in a weaker lightweight board.

An additional process variable is the foam or foaming agent. The foaming agent is inserted into the stucco to increase voids and lessen the density of the final product. However, foamed gypsum may be less suitable than unfoamed gypsum for the edges of the gypsum board product, where the fastening of the board to the framing is generally accomplished, due to the lower nail-pull value of foamed gypsum. Therefore, a gypsum slurry having less foam and a higher density is more desirable at the edges.

U.S. Pat. No. 4,279,673, issued to White et al., discloses a secondary mixing and agitation system for producing gypsum with less foam and higher density. The foamed gypsum disposed directly along the edge of the gypsum board product prior to facing and forming. U.S. Pat. No. 5,683,635, issued to Sucech et al, discloses a single mixer from which a portion of gypsum with less foam and higher density is removed from the mixture, bypasses the foam insertion point, and is disposed directly along the edge of the gypsum board product prior to facing and forming.

A further process variable is selecting means for injection of foam into a gypsum mixer. Generally, such injection must overcome the backpressure at the injection point, which may vary by mixer type, mixing conditions, and injection location.

Methods to inject the aqueous foam into the gypsum board product production stream are known. U.S. Pat. No. 4,057,443, issued to Stiling et al., discloses a foam generator in which the foam produced in a foam generator cell is gravity feed into the calcined gypsum at the center of a pin mixer. U.S. Pat. No. 4,735,755, issued to Bischops, discloses foam produced under pressure in a foam generator and injected into the final product at the last moment. U.S. Pat. No. 5,227,100, issued to Koslowski et al., discloses a foam mixture added to mixing units via a foam gun. U.S. Pat. No. 4,455,271, issued to Johnson, discloses passing an aqueous surface active agent through a two phase cylindrical static mixing tube under directed air and water streams to produce a foam that is mixed with calcined gypsum in a mixing device. U.S. Pat. No. 5,714,032, issued to Ainsley et al., discloses a two stage mixer. Foam is added to a gypsum slurry in a second mixer and the foamed gypsum is discharged and, with unfoamed gypsum slurry diverted from the first mixer, forms a gypsum board product.

Therefore, there is an overall need to develop a gypsum board product that is lightweight and has adequate mechanical characteristics. Further, there is an overall need to provide improved process variables to contribute to an improved lightweight gypsum board product.

### SUMMARY OF THE INVENTION

It is an object of the present invention to provide a lightweight gypsum wallboard having adequate strength and nail pull resistance.

It is a further object of the present invention to produce a lightweight gypsum tile that can be used for ceiling tiles.

According to one embodiment of the present invention, a gypsum board can be made using the components set forth in Table 1.

According to another embodiment of the present invention, a gypsum board can be made using the components listed in Table 2.

According to a further aspect of the present invention, gypsum board products can be produced using a foam generator and a foam composition which increases efficiencies in the production process.

It is an object of the present invention to utilize an aqueous foaming agent and a foam generator in the production of gypsum board products and to use a range of fiberglass, polyester or other fibers, dispersants, accelerators and foamed surfactant in the production of gypsum board products.

It is a further object of the present invention to reduce water usage, increase foam efficiency, and reduce energy consumption in the production of gypsum board products.

According to an aspect of the present invention, a range of fiberglass, polyester or other fibers, dispersants, accelerators and foamed surfactant may be utilized in the production of gypsum board product. A foam generator and a foaming agent in conjunction with high pressure air can produce a foam that results in void sizes that are ≦500 μm and the void concentration can be such that the density of the gypsum board product can be reduced resulting in a lightweight product. A lightweight board can be produced with a dry weight of ≦1275 lbs./msf (msf=1000 sq. ft.). The lightweight board has suitable mechanical properties, such as nail pull values of approximately 85 to 95 force lbs., flexural strength, depending on board location tested, from approximately 45 to 85 force lbs., and humidified deflection with a 2-3 mm. deflection distance.

Such gypsum board products can be made either with paper on both sides thereof, paper on one side thereof, or without paper on either side thereof.

### DETAILED DESCRIPTION OF THE PREFERRED EMBODIMENTS

Although the description herein may from time to time refer to either a wallboard or a ceiling tile or a ceiling board, or collectively to gypsum board product, in each case, the concepts of the present invention may be applied generally to wallboards, fiber boards, ceiling boards, or ceiling tiles.

Generally, gypsum board product is produced by mixing together components to form a slurry, casting the slurry onto a paper, allowing the slurry to set, cutting the cast product into boards, and drying the gypsum board product. The production process can have many variations depending on the desired properties and characteristics of the final product. For example, the production process can be either continuous or a batch process.

In a continuous process a high shear mixer is continuously and contemporaneously fed with the components of the gypsum board product while a continuous casting process and assembly line produces the finished product. An example of such a continuous process is utilized in the production of wallboard. In wallboard, the components of the slurry are cast between two sheets of paper which form the finished and the unfinished surface of the wallboard.

In contrast to a continuous process, a batch process can be utilized for the production of ceiling tiles. Batch processing describes the mixing in a single operation of a metered quantity of gypsum board product constituents. The quantity of gypsum board slurry is then substantially completely used in subsequent production step prior to addition and mixing of further gypsum board product constituents. In ceiling tile production, a batch of slurry is prepared and cast between sheets of paper. During the subsequent setting, cutting, and drying processes, the sheet of paper is removed from one or both sides of the gypsum board product.

Gypsum board product comes in many sizes and thicknesses. For example, gypsum board product can be produced in ⅜ inch board, ½ inch board, or ⅝ inch board. These common sizes are well known to those in the art. However, what is not well known is how to produce a lightweight gypsum board product that is neither too thin and fragile nor too heavy, yet displays adequate strength and nail pull.

The desired characteristics of lightweight and mechanical characteristics can be achieved by control of the components utilized to make the slurry. Table 1 lists components utilized in production of an exemplary embodiment of a ½ inch lightweight gypsum board product. The components of Table 1 can be utilized, for example, in the production of a half inch lightweight wall board with paper on both sides. The gypsum board product produced from the components in Table 1 has a finished product weight of approximately 1432±200 lbs./msf (msf=1000 sq. ft.).

TABLE 1
(½″ board)

| | | |
|---|---|---|
| | Range | Preferred Amount |
| Component | (lbs/msf) | (lbs/msf) |

Non-Water Components

| | | |
|---|---|---|
| starch | 6-12 | 8 |
| liquid dispersant | 0-3.5 | 2.5 |
| BM accelerator | 2-10 | 7 |
| boric acid | 0-3 | 2.7 |
| glass fiber | 0-10% | 0 |
| foaming agent-surfactant | 0.2-1.2 | 0.8 |
| retarder | 0-0.5 | 0.25 |
| bundling glue | 0.1-0.4 | 0.3 |
| asphalt wax/emulsion | 0-5 | 0 |
| edge paste | 0.5-1.5 | 0.93 |
| paper | 80-100 | 85 |
| potassium sulfate | 0-4 | 0 |
| reclaim | 0-200 | 0 |

Water Components

| | | |
|---|---|---|
| gauging water | 250-400 | 336 |
| pulp water | 200-300 | 252 |
| foam water | 200-300 | 252 |
| total water (cumulative of above) | 650-1000 | 840 |

Other Variables

| | | |
|---|---|---|
| stucco | ±200 | 1130 |
| w/s ratio | 0.65-0.9 | 0.74 |
| board wet weight | ±300 | 1545.92 |
| board dry weight | ±200 | 1432 |
| evaporation | ±300 | 669 |

Strength and weight are important criteria in a gypsum board product. Both the strength and the weight can result in inadequate performance of thinner wallboard and/or higher costs in thicker wallboards.

A ½ inch board may be too thin to use as a ceiling tile. Therefore, ceiling tile that has either no paper or paper on only one side is typically ⅝ inch thick. In contrast, wallboard gypsum board product has paper on two sides which imparts a higher strength and nail pull characteristic. Therefore, ⅜ inch and ⅝ inch gypsum board wallboard product can be manufactured from the values in Table 1 using appropriate proportional constants for the difference in thickness. For example, a ⅝ inch board would utilize the components in Table 1 multiplied by a 1.25 factor.

An exemplary embodiment of the components in a gypsum board product utilizing no paper is given in Table 2. Alternatively, paper can be included on one side of the gypsum board product. The values given produce a gypsum board product suitable for use as a ceiling tile and displaying adequate nail pull and flex strength. The gypsum board product produced from the components in Table 2 has a finished product weight of approximately 1380±200 lbs./msf (msf=1000 sq. ft.).

TABLE 2
(⅝″ board)

| | | |
|---|---|---|
| | Range | Preferred Amount |
| Component | (lbs/msf) | (lbs/msf) |

Non-Water Components

| | | |
|---|---|---|
| starch | 0-12.5 | 0 |
| liquid dispersant | 0-4.375 | 0 |
| BM accelerator | 0-12.5 | 2.35 |
| boric acid | 0-3.75 | 0 |
| glass fiber | 0-18.75 | 6.5 |
| foaming agent-surfactant | 0.25-1.25 | 0.55 |
| retarder | 0-0.5 | 0.18 |
| bundling glue | | 0 |
| asphalt wax/emulsion | 0-6.25 | 0 |
| edge paste | | 0 |
| paper | | 0 |

Water Components

| | | |
|---|---|---|
| gauging water | 200-400 | 282 |
| pulp water | | 0 |
| foam water | 600-900 | 750 |
| total water | 800-1300 | 1032 |

Other Variables

| | | |
|---|---|---|
| stucco | ±200 | 1200 |
| w/s ratio | 0.7-0.95 | 0.86 |
| board wet weight | ±200 | 2332 |
| board dry weight | ±200 | 1380 |
| evaporation | 700-950 | 852 |

An additional exemplary embodiment of the components in a gypsum board product utilizing paper on only one side is given in Table 3. The values given produce a gypsum board product suitable for use as a ceiling tile and displaying adequate nail pull and flex strength. The gypsum board product produced from the components in Table 3 has a finished product weight of approximately 1436±200 lbs./msf (msf=1000 sq. ft.).

TABLE 3
(⅝″ board with paper on only one side)

| | | |
|---|---|---|
| | Range | Preferred Amount |
| Component | (lbs/msf) | (lbs/msf) |

Non-Water Components

| | | |
|---|---|---|
| starch | 0-12.5 | 0 |
| liquid dispersant | 0-6 | 6 |
| BM accelerator | 0-12.5 | 8.5 |
| boric acid | 0-3.75 | 1.3 |
| glass fiber | 0-20 | 20 |
| foaming agent-surfactant | 0.25-2.6 | 2.6 |
| retarder | 0-0.5 | 0.18 |
| bundling glue | | 0 |
| asphalt wax/emulsion | 0-6.25 | 0 |
| edge paste | | 0 |
| paper | | 92 |
| | | (release type paper) |

Water Components

| | | |
|---|---|---|
| gauging water | 200-700 | 664 |
| pulp water | | 0 |
| foam water | 300-900 | 312 |
| total water | 500-1600 | 976 |

Other Variables

| | | |
|---|---|---|
| stucco | ±200 | 1135 |
| w/s ratio | 0.7-0.95 | 0.86 |
| board wet weight | ±200 | 2242 |
| board dry weight | ±200 | 1435 |
| evaporation | 700-950 | 806 |

According to one preferred embodiment of the present invention, gypsum board product can be made using the components set forth in either Table 1, Table 2 or Table 3. The components are preferably used in the quantity listed in the column titled “preferred amount”.

Starch: The starch utilized in the preferred embodiments of the present invention is preferably a wheat starch. One purpose of the starch is that when the starch is dispersed within the board, as the board sets, the starch migrates to the surface of the board and helps bind the paper to the board. In boards where paper is not used, there is generally no need to include the starch. However, in boards that include paper on one or both sides thereof, the starch is preferably used in the range of 6 to 10 lbs. per thousand square feet.

Dispersant: According to a preferred embodiment of the present invention, a liquid dispersant is blended with the components. A preferred type of liquid dispersant is made by the Dial-a-Flow Corporation, and is a lignin-based dispersant. The dispersant helps blend the components together, and functions like a wetting agent or plasticizer. The dispersant increases the effective fluidity of the mix.

Accelerator: The BM accelerator is a ball milled accelerator. The accelerator is used to adjust the set time of the gypsum. The accelerator includes small crystal-like objects which are coated with a starch or other dissolvable substance. As the coating is dissolved off of the crystals, the accelerator crystals form a starting point or seed for crystal growth of the gypsum. By controlling the quantity of accelerator used, the setting time of the gypsum board can be adjusted.

Boric Acid: In some embodiments of the present invention, boric acid can be used to increase the stiffness of the board. Boric acid tends to shorten the crystals in the gypsum matrix, thus enabling the board to be stiffer. As a result of the shortened crystals and stiffer board, the board is frequently weaker. Boric acid is frequently used in gypsum boards where it is intended to snap the board along score lines.

Fibers: Fibers can be added to the board components in order to increase the strength thereof. The fibers can be any number of types of materials, including polyester or fiberglass. The fibers are preferably about ½ inch in length, but can be longer or shorter, as desired or available.

Foaming Agent: A foaming agent is used to add air to the core of the board in order to lower the density thereof. A foaming agent that can be used is a surfactant sold under the trade name “Thatcher”.

Retarder: Retarder is preferably added to the board components in order to delay the set time of the gypsum. The retarder has no long term effect on the strength or other characteristics of the board. It is desirable to delay the set time under certain circumstances so that the slurry does not set earlier than desired. If the gypsum slurry begins to set in the mixer, inefficiencies result. In addition, if the slurry sets beyond the mixer but prior to casting, casting of the slurry can cause crystal structure to be disrupted during the setting process, which will result in a weaker final board. Accordingly, retarder can be used to adjust the set time of the gypsum.

Bundling Glue: Bundling glue may be used to adhere a tape to the edge of the board in order to secure a plurality of boards together after manufacture.

Asphalt/Wax Emulsion: An asphalt or wax emulsion can be added to the board components in order to provide a water resistant quality to the gypsum board.

Edge Paste: Edge paste can preferably be used to hold an edge paper onto the top of the gypsum board.

Paper: Paper can be used to form the facing and back of a gypsum wallboard. The paper can be anywhere between a 40 to 60 lbs. weight. In some applications, a paper blended with polypropylene fibers can be used.

Potassium sulfate: Potassium sulfate can be used as a set modifier. The set modifier is utilized when production is made in a hot environment. For example, potassium sulfate from 0 to 4 lbs./msf, preferably 0 lbs./msf, can be introduced into the slurry to effect the set, and adjust the curve between the initial and final set of the product.

Reclaim: The production of gypsum board product may include the use of reclaimed gypsum board product. For example, scraps, shavings, and rejected gypsum board product may be milled down to the appropriate sizes and reintroduced into the mixer to be formed into the slurry. In the listing of Table II, the reclaimed gypsum board product can be from 0 to 2000 lbs./msf, but is preferably 0 lbs./msf.

Stucco: For the stucco, a beta or a modified beta plaster can be used. However, other types of stucco, such as alpha plaster can also be used. The stucco is blended with water at a water to stucco ratio preferably within the range of 0.65 to 0.9. The ratio refers to the weight of water divided by the weight of the stucco used. Some of the water added to the mixture will be rehydrated into the plaster and permanently retained in the board. However, some of the water will be evaporated off.

Stucco is prepared in a calcining process. During the calcining process, water driven from the gypsum leaves behind a porous calcined product. This porous product is then partially rehydrated to a small extent, such as with 5-10 weight percent water, to form a modified beta product. This modified or stabilized gypsum is less susceptible to the strength reduction that is typically seen in traditional β-gypsum. Therefore, the strength of a resultant gypsum board product can be improved by using a modified β or stabilized β-gypsum.

The partial rehydration of the calcined gypsum can be accomplished at any suitable point after calcination. For example, the gypsum may be rehydrated soon after calcination and then stored, shipped, or otherwise handled, prior to its introduction as a component in a lightweight gypsum board slurry. Alternatively, the rehydration process can occur as a separate standalone process intermediate to the calcination and prior to use as a component in the gypsum board slurry. Finally, the partial rehydration can occur immediately before introduction of the stucco as a component of the gypsum board slurry.

Water: The amount of gauging water utilized in production of gypsum board products is a function of the amount of gypsum or stucco. Gauging water is used to ensure that the stucco is fully hydrated. The pulp water is used as a component in gypsum board products as a medium to carry dry and liquid components into the mixer. Foam water is added to the foaming agent to produce a standing foam that is introduced into the gypsum board product processing. Overall, the fluidity or total water content varies from 500 to 1600 lbs./msf and preferably from 650 to 1050 lbs./msf of gypsum board product. In general, the gypsum board slurry is overhydrated for viscosity reasons. The overhydration is subsequently removed during a drying step in the oven.

Production: The components in Tables 1, 2 and 3 can be utilized to form a lightweight gypsum board product using known processing techniques. For example, gypsum components can be introduced into a pin mixer and mixed to a slurry. The slurry is forced to the edges of the pin mixer by centrifugal force. A gate, substantially a tapered rectangular passage in the outer circumferential wall of the pin mixer, is mounted with the axis of the passage at an acute angle to the momentum vector of the slurry in the pin mixer. Gypsum slurry enters the gate under centrifugal forces and is directed to a static helical mixer.

Alternatively, the desired characteristics of lightweight and mechanical characteristics can also be achieved by the use of a foaming agent inserted in to the process at a suitable position. For example, an aqueous foam, generated in a separate process and then directed to the gypsum slurry process, can be inserted into the pin mixer.

Unfoamed or foamed slurry is discharged and cast between sheets of paper to form the lightweight wallboard product. In one alternative method, the slurry is cast between sheets of paper and subsequent to setting, one or both of the sheets of paper are removed to form a lightweight gypsum board product such as a ceiling tile, ceiling boards, or fiber board. In an additional alternative method, the slurry is cast between continuous or endless sheets that, subsequent to setting, can be removed from one or both sides of the gypsum board product and then conveyed back to the casting location in the process.

In an exemplary process, the static helical mixer can provide two functions. First, the static helical mixer provides back pressure to the pin mixer and flow regulation to the gypsum slurry prior to depositing on the conveyed casting surface. Thus, the static helical mixer serves to transition the slurry from the high shear, high velocity pin mixer environment to the lower velocity casting environment.

Second, the static helical mixer provides additional mixing of the slurry components. This mixing is accomplished non-motively by an internal helical path that turns the gypsum slurry approximately 450-540° in clockwise rotation to deposit the slurry on the casting surface. Both the reversal of rotation direction and the tortuous path of the helical mixer contribute to create turbulent flow and to mix the gypsum slurry and the foam. The resultant gypsum board product has both small void sizes and uniform void dispersion.

In another exemplary process, a ⅝ inch thick gypsum board product is produced from the components included in Table 3. The additives resulted in a sharp set of the gypsum before the knife operation. Releasable paper was utilized and removed from the front face through tensioned rollers and dropped through the floor. Alternatively, an endless belt or other suitable device can be utilized on which the gypsum slurry is cast and which is ultimately removed from the gypsum after the set. The unwrapped face passes over clean shrink wrapped rollers to the wet transfer point, where it is flipped on to the backside paper and conveyed for a dryer set process. The line speed is 80 feet per minute.

One foaming agent that is suitable for use in the production of gypsum board product is “Thatcher.” Thatcher, in conjunction with a foam generator, produces small, uniform bubbles throughout the cross-section of the gypsum board product. In one aspect the of foam generation, air at approxiamtely 100 psi or higher is forced into the foam generator apparatus. A suitable foam generator apparatus can be a packed bed type foam generator in which a tube or other elongated chamber is packed with beads, tiles, saddles, or the like. As the high pressure air, surfactant/foaming agent, and foaming water are forced through the packed bed, a foam is formed having the desired characteristics. Alternatively, other foam generators can be used that allow for a similar high pressure air function.

Using the “Thatcher” foaming agent and an air pressure of approximately 100 psi, a typical bubble size may be 100 μm or less. In general, smaller uniform bubbles produce a stronger gypsum board product. For example, small uniform bubbles in conjunction with modified β-gypsum crystallization produces a gypsum board product with the required strength to meet wallboard target weights and satisfy nail pull and flex strength requirements.

In one aspect, it has been determined that gypsum board product having a dispersion of bubbles can be both lightweight and have the desired mechanical characteristics such as strength and nail pull. Such a gypsum board product is provided when the bubbles are ≦500 μm in diameter. Preferably, the bubbles are 80-300 μm in diameter. Further, the gypsum board product can contain microbubbles, defined as bubbles having a diameter ≦80 μm. The bubbles can be substantially uniformly dispersed throughout the gypsum slurry and the set gypsum board product.

In another aspect, the foam can have a density of 2-6 lbs/cubic foot as opposed to the standard 6-20 lbs/cubic foot commonly used in the manufacture of gypsum board. In addition, the bubbles will likely have 2 to 15 times the durability or life span as specified in a timed drainage test known as the “quarter drain” compared to that of the typical foams used in the manufacture of gypsum board product. In the “quarter drain” test, a foam sample is collected in a unit cylinder and allowed to sit. A stopwatch is used to record the number of seconds that it takes for one quarter of the initial sample weight to drain into solution as the foam bubbles burst and return to solution.

In order to produce a gypsum board according to the present invention, according to one preferred embodiment, the components set forth in Tables 1, 2 or 3 are blended together to form a stucco slurry. A facing sheet is laid out on an endless conveyor belt, and the slurry is deposited onto the facing sheet. A backing sheet is then laid on top of the slurry. The sandwich of the facing sheet, the slurry, and the backing sheet is then pulled by the conveyor belt through forming plates to form the precise desired thickness of the board. The “sandwich” is then carried by the conveyor belt until an initial set time expires. At that point, a cutting blade is used to slice the board into desired lengths. The cut lengths of the board are then passed through a dryer to remove any excess water. At any stage during the process, either the facing sheet or the backing sheet, or both may be removed.

In an alternative embodiment of the present invention, the gypsum board can be formed in a line generally known for making ceiling tiles. In such a process, the desired components are blended with a high shear mixer in a batch process. The batch is then extruded through a rectangular opening of an extruder onto an endless conveyor belt. After a predetermined initial set time, the mixture is then cut into desired lengths. The cut lengths are then passed through a dryer to evaporate the excess water.

According to the present invention, lightweight gypsum boards can be made. The density of such boards can range from as low as 32 lbs./ft³ to about 35 lbs./ft³. Additionally, ceiling tiles with paper on only one or on neither side can have a density ranging from 22-26 lbs./ft³.

In two examples, ½ inch thick gypsum boards were made consistent with the formulation contained in Table 1. The ½ inch gypsum boards were made with paper on both sides. After setting and drying, the gypsum boards had a dry weight of approximately 1235 and 1255 lbs./msf, respectively. The gypsum board products were tested for mechanical properties. Specifically, flexural strength, nail pull, and humidified deflection were determined.

Flexural Strength: The transverse strength and deflection of gypsum board products is measured by a transverse test on samples subject to a controlled environment. Flat and warp-free samples were selected from current production, cut into sample size and tested within one-half hour after removal from the dryer. A moisture meter ensured the board selected was neither wet nor calcined. Alternatively, a board not tested within ½ hour after removal from dryer, i.e., taken from stock, etc. . . . , was conditioned in a drying oven at 120° F. for 4-5 hours. Further, the samples were conditioned to constant weight in an atmosphere with temperature of 70° F. to 100° F. and 50±2% Relative Humidity (RH).

Surfaces of boards to be tested were visually inspected to be free from scuffs, nicks, indentations, or any defect that would adversely affect the results in the area tested.

A sharp knife scored or cut the board so the edges were clean cut. From one full size test board, four samples were cut each at least 4″ away from the edges and ends. The standard size of the transverse strength test sample was 12″×16″. Of the four samples, two were cut with the 12″ dimension exactly at right angles to the machine direction of the board (or at right angles to the surface paper fiber direction) and two shall were cut with the 16″ dimension exactly at right angles to the machine direction (or at right angles to the surface paper fiber direction). All four corners of each sample were at a 90° angle. A center line was drawn lightly with a pencil midway between the 12″ (or 16″) edges of the test sample and on the side of the sample that will be in contact with the transverse tester breaking beam. This line was used for centering and proper aligntnent of the breaking beam on the sample.

A transverse tester was equipped with an 80 lbs. shot bucket and a shot feeder extension. The tester lever arm with breaking beam blade assembly attached was balanced to a horizontal position with the shot bucket by adjusting the balancing weight on the end of the lever arm. The two supporting knife edges were positioned in the slots of the machine bed to give a 14″ span between the two lines of contact on the board so that the breaking beam blade was centered between the two supports. The sample was placed on the two supporting knife edges, and aligned so that the breaking beam blade coincided with the center line of the 16″ sample. The breaking beam was pressed against the roller guide and re-balanced until it just contacted the board surface without deflecting the sample. While the breaking beam was held in this position, the deflection scale was set at 0 to coincide with the deflection-indicating pointer on the lever arm.

Samples were continuously loaded with shot placed into the bucket at the rate of 12±1.2 lbs./minute (≈60 lbs/minute of force). The shot is No. 6 zinc coated (approx. 0. 110″ diameter) available from Reloading Specialties, Inc., Pine Island, Minn. 55963. The indicator pointer was watched closely to determine the deflection at the time the board breaks. The deflection was reported in 1/16 inch increments. The transverse strength value for the 12″×16″ sample was calculated by multiplying by 5 the shot weight at breaking. This calculation was based on the length of the lever arm (20″) vs. distance from bearing to fulcrum (4″) or a ratio of 5 to 1. Four transverse strength values were obtained from one full size test board. The 12″×16″ samples were tested for face up and face down strength, both “with” and “across” machine direction, and the results reported individually for each sample.

Nail Pull: Nail pull measures the resistance of gypsum wallboard to nail pull-through. A 6″ strip is cut across the width of a 48″ gypsum board product and cut into five 6″×6″ (152 mm x 152 mm) specimens, the cut for each specimen was not less than 4″ (102 mm) from either edge. Specimens had a 7/64″ (2.8 mm) pilot hole drilled perpendicularly through the center and is conditioned for at least 24 hours at a temperature of 85±15° F. (29.5±8.5° C.) and a relative humidity of 50±2%. Alternatively, specimens can be tested without conditioning, but the results are clearly indicated as such and are not reported with test results for conditioned specimens.

After preparation, specimens were placed face up on a support plate of a transverse tester modified with a test nail shank. The test nail shank was manually lowered into the pilot hole until the nail head was flush with the face of the test specimen. A load was applied to the specimen by the use of metal shot (No. 6 zinc coated available from Reloading Specialties, Inc., Pine Island, Minn. 55963) placed in the bucket of the transverse tester. Maximum load was the load at which the nail head breaks through the specimen surface. The average maximum force in pounds-force, rounded to the nearest 1 lb-f was calculated using the lever arm ratio of 5:1 and discarding any single test that varied from the average by more than 15%. If two or more results were discarded, the entire test was repeated.

Humidified Deflection: Humidified deflection provides a measurement of the deflection of gypsum board in a high humidity (90%) environment. Two samples (12 in.×24 in.) were cut at least 12 inches from the ends and edges of the board and with the 12 in. dimension parallel to the length of the board. The samples were then condition to constant weight at 50±2% RH, 85° F.±15° F. (29.5° C.±8.5° C.). Conditioned samples were then placed face down on a suspension rack in a humidity cabinet or room. A suspension rack has a pair of parallel and level bearing surfaces at least 12 inches long and spaced 23 inches apart. A bearing edge on the suspension rack has a ⅛ in. radius. Deflection was recorded initially and after 48 hours and was measured as the distance between a straight edge placed across the top end edges of the sample and the upper surface at the center of the sample. Humidified deflection was reported as the difference between the finial deflection and the initial deflection.

The nail pull results for the ½ inch product indicates nail pull values of approximately 85 to 95 force lbs. Flexural strength varied depending on board location tested from approximately 45 to 85 force lbs. Humidified deflection indicated a 2-3 mm. deflection distance. Tables 4-6 contain test results for these mechanical properties.

TABLE 4
NAIL PULL

| Sample | Force lbs. |
|---|---|
| 1A | 90.10 |
| 2A | 86.80 |
| 3A | 93.60 |

TABLE 5
FLEXURAL STRENGTH

| Sample | Location | Direction | Force lbs. |
|---|---|---|---|
| 1A | END | MACHINE DIR | 45.4 |
| 2A | END | MACHINE DIR | 50.4 |
| 3A | END | MACHINE DIR | 46.2 |
| 4A | MIDDLE | MACHINE DIR | 46.3 |
| 5A | MIDDLE | | 85.0 |
| 6A | MIDDLE | | 85.0 |
| 7A | MIDDLE | | 81.7 |

TABLE 6
HUMIDIFIED DEFLECTION

| Sample | Direction | Deflection (mm) |
|---|---|---|
| 1A | MACHINE DIR | 2 |
| 2A | MACHINE DIR | 3 |
| 3A | MACHINE DIR | 2 |
| 4A | MACHINE DIR | 3 |
| 5A | MACHINE DIR | 3 |
| 6A | MACHINE DIR | 2 |

Thus, in accordance with the present invention, a light weight gypsum board product having a weight of ≦1275, and more preferably a weight of ≦1250, can have mechanical properties as set forth in Tables 4-6.

Although the present invention has been described in connection with exemplary embodiments thereof, it will be appreciated by those skilled in the art that additions, deletions, modifications, and substitutions not specifically described may be made without departing from the spirit and scope of the invention as defined in the appended claims.

1. (Original) A method of making a gypsum board comprising:
mixing together gypsum and water in a mixer to form a gypsum slurry;
discharging the gypsum slurry onto a first facing sheet;
laying a second facing sheet on top of the discharged gypsum slurry;
passing the gypsum slurry and facing sheets through a forming station to form the slurry to a desired thickness;
allowing the formed gypsum slurry to set;
removing at least one of the facing sheets from the set gypsum;
cutting the set gypsum into boards; and
drying the cut gypsum boards.

2. (Original) The method of claim 1, wherein the removing step includes removing both the first and second facing sheets.

3. (Original) The method of claim 1, wherein the mixing step includes mixing foam with the gypsum and water.

4. (Original) The method of claim 3, wherein the mixing step includes mixing the gypsum, water and foam such that the following quantities are mixed for each 1000 square feet of board:
0.2-1.2 lbs. foaming agent-surfactant;
650-1000 lbs. water; and
≦1330 lbs. gypsum.

5. (Original) The method of claim 4, wherein the mixing step further includes mixing the following quantities for each 1000 square feet of board:
6-12 lbs. starch;
0-3.5 lbs. liquid dispersant;
2-10 lbs. BM accelerator;
0-3 lbs. boric acid;
0-10% glass fiber;
0-0.5 lbs. retarder;
0-5 lbs. asphalt wax/emulsion;
0-4 lbs. potassium sulfate; and
0-200 lbs. reclaim,
wherein the water comprises 450-700 lbs. water and 200-300 lbs. foam water.

6. (Original) The method of claim 1, wherein the passing step includes forming a gypsum board product that is ½ inch thick.

7. (Original) The method of claim 1, wherein the passing step includes forming a gypsum board product that is ⅝ inch thick.

8. (Original) The method of claim 1, wherein the gypsum boards are ⅝ inch thick and are paper-free and wherein the gypsum boards has a total dry weight of ≦1400 lbs/msf after drying.

9. (Original) The method of claim 1, wherein the gypsum board product is ⅝ inch thick and has paper on only one side and wherein the gypsum board product has a total dry weight of ≦1450 lbs/msf after drying.

10. (Original) The method of claim 1, wherein the first facing sheet is a releasable paper.

11. (Original) The method of claim 1, wherein the first facing sheet is an endless belt, and the endless belt is separated from the gypsum board subsequent to the setting of the gypsum slurry.

12. (New) The method of claim 1, wherein the at least one facing sheet is removed prior to the drying step.
